(19) United States
(12) Patent Application Publication
(10) Pub. No.: US 2003/0232651 A1
(43) Pub. Date: Dec. 18, 2003

(54) Method and system for controlling and managing bets in a gaming environment

(76) Inventors: Marcel Huard, St-Romuald (CA); Real Berube, St-Jean-Chrysostome (CA); Martin Benoit Gagnon, Levis (CA); Guillermo Loria Santa Maria, San Jose (CR)

Correspondence Address: OGILVY RENAULT, 1981 MCGILL COLLEGE AVENUE, SUITE 1600, MONTREAL, QC, H3A2Y3, CA

(21) Appl. No.: 10/409,475

(22) Filed: Apr. 9, 2003

Related U.S. Application Data
(63) Continuation-in-part of application No. PCT/CA01/01468, filed on Oct. 22, 2001.
(60) Provisional application No. 60/241,740, filed on Oct. 20, 2000.
(60) Provisional application No. 60/296,486, filed on Jun. 8, 2001.
(60) Provisional application No. 60/296,453, filed on Jun. 8, 2001.

(51) Int. Cl. G06F 17/00

(52) U.S. Cl. 463/42

(57) ABSTRACT

The present invention relates to a method and system for controlling and managing bets in a gaming environment. The present invention provides simplified betting options for casino games. Betting options being less complex are less demanding in terms of concentration and/or real-time inputs from the player during the proceeding of the underlying casino game. Consequently, players are in a better disposition for enjoying the atmosphere, and the intrinsic activity of play of the underlying game or for pursuing another activity at their ease such as drinking at bars, playing at another casino game or simply observing the underlying game.

### CROSS-REFERENCE TO RELATED APPLICATION

This application is a Continuation-In-Part of PCT patent application serial number PCT/CA01/01468 filed on Oct. 22, 2001.

### BACKGROUND OF THE INVENTION

1. Field of the Invention

The present invention relates to a method and system for controlling and managing bets in a gaming environment. More particularly, the invention relates to a method and system for controlling and managing bets for a game played remotely from where the underlying live game is played.

2. Description of the Prior Art

An auxiliary casino game is a game associated with an underlying principal casino game. The auxiliary game offers players additional opportunities to win prizes in addition of prizes offered by the principal casino game. The auxiliary game is an additional enjoyment feature and incentive to bet for a player. The betting rules of an auxiliary game are simple in a manner to not disturb or slow the principal casino game, and to not render the betting operation more complex for the player. Also, by its simplicity and its rapidity, the auxiliary game can be played in conjunction with a principal casino activity more complex. Consequently, an auxiliary game is an additional source of craze for playing to players at a principal casino game in offering in same time an additional chance to win prizes and possibility of enjoying atmosphere and intrinsic activity of the principal casino game.

For a casino, the auxiliary game, being simple and quick, is a real source of profitability in not slowing the pace of the principal game, in constituting an incentive to bet, and a dedication source to play for players, and in permitting an additional possible source of gains provided by auxiliary bets.

Casinos would like to offer to their clients the atmosphere, and the intrinsic activity of a principal casino game, regardless to which activity a client is occupied to, and where he is located inside a casino—such as at a slot machine, at a video gaming machine, at a casino table game—or outside a casino—such as at a bar, in an hotel room. Nevertheless, casinos do not wish that a such activity, played remotely from the location where is played the principal casino game, interferes or slows proceedings of the principal game, and in same time, that this activity played at a remote location interferes or slows the pace of the principal activity to which a player is occupied to at a remote location where the underlying principal game is played.

Actually, the features of auxiliary games are reserved exclusively to players located in proximity of the game casino table, participating, or not, in the principal casino game.

U.S. Pat. No. 5,540,442 to Orselli, et al. describes a modified roulette game offering an additional betting opportunity with a large payoff for winning bet, a player having made a conventional roulette bet on the conventional roulette betting layout, may make a second, or side bet, on a related betting layout, without regard to color, parity or position. When the winning bets in the conventional layout are determined by the operation of the roulette wheel, a random number generator also generates and displays one of the conventional roulette numbers, i.e. 1-36, 0 or 00. If the number displayed by the random generator is the same as the winning number that is determined by the roulette wheel, the side bet on that number is a winning number. In Orselli et al. a player has to participate in the principal live table (roulette) game, to be able to make a second or a side bet.

U.S. Pat. No. 6,059,659 to Bush, et al. describes a method for playing roulette with a system including a roulette wheel, a conventional betting layout and a progressive jackpot layout. Players make wagers on the conventional layout and/or the progressive layout to participate in a progressive jackpot game wherein the jackpot is accumulated from losing wagers on the progressive jackpot layout. The system includes sensors for detecting chips placed on the progressive layout. The jackpot is won by a wagered winning number being selected by the roulette wheel in a predetermined number of successive spins. In Bush et al., the player has to be at the roulette table to make wagers on the progressive layout. A prize from the progressive jackpot is awarded only when a wagered winning number is selected by the roulette wheel in a predetermined number of successive spins.

U.S. Pat. Nos. 5,743,800, 6,146,270 and 6,139,430 to Huard et al. describes an auxiliary game providing an auxiliary opportunity for players at a casino to win a prize by participating with relatively small contribution each time they play a round in the principal casino game. To increase the element of random chance or luck in winning prize in the game, a method and apparatus is provided for randomly choosing a winning gaming symbol or a combination of gaming symbols, or randomly selecting a person or a group of persons eligible to win upon possession of the gaming symbol or combination of gaming symbols. In Huard et al., a player for having a chance of winning an auxiliary prize has to participate in the live casino table game to get a number of gaming symbols, or at least, has to occupy a player position around the table of the underlying live casino table game.

In other hand, the possibility to bring at a remote location from a table of a live casino table game—inside or outside of a casino—the atmosphere and the intrinsic activity of a principal casino game already exists:

U.S. Pat. No. 4,467,424 to Hedges, et al. describes a remote gaming system for use with a wagering or gambling establishment such as casino to enable a player's participation in a selected one of plurality live table wagering games from a remote location, such as roulette, keno or craps.

U.S. Pat. No. 5,800,268 to Molnick describes a method by which a player may participate in a live casino game from a remote location from the casino is disclosed. A player establishes an information link with a casino from an interface station including a video monitor and keypad. In response to the player's entry of financial account information, the casino establishes an information line with the player's financial institution. The casino assigns the player to a gaming table at which a “live” game is occurring, transmitting all images of game play information to the casino. Because of the open line between the casino and player's financial institution, bets are checked, winning paid, and losses debited instantaneously.

Nevertheless, the systems permitting a player to feel the atmosphere, and the intrinsic activity of a principal casino game played at a remote location offers integrally the principal game, constituting, then, the primary activity of a player. Consequently the player has no more opportunities or time for enjoying the casino atmosphere or for participating in another game. The establishment of a system for participating in a principal game, played at a remote location, results in an addition of a number of player positions for participating in a principal game, and not, in an addition of an auxiliary game that can be played in parallel with any other principal activity offered by a casino. For example, a system for playing a principal game from a remote location installed inside a same casino, wherein the principal game is played, corresponds to an increasing of the number of available player positions for the principal game. The implementation of such a system results at its best, in an increasing of the number of clients for a casino, at its worst, results in a shift of one or many players from a principal activity to another principal activity inside a same casino. Such system of participating in a principal game from a remote location does not constitute an addition of auxiliary game features to the principal activity of a client or a player in a casino. Consequently, no incentive or additional features are added to the principal player activity. These facts are opposite to goals pursued by casinos when they want to implement an auxiliary game being played at a remote location from where the underlying casino game is played.

A method and system permitting to bring to players the features of an auxiliary game at a remote location from where the underlying principal game is played, and regardless where, and to which activity players are occupied to, would constitute a major and an innovative step in the casino industry.

### SUMMARY OF THE INVENTION

It has been found that extending the features of an auxiliary game played in conjunction with an underlying casino game to a number of players in addition of players participating in and/or located at the underlying casino game provides new and interesting features for enhancing the enjoyment and the dedication of players for the plurality of games and activities offered in, and outside a casino environment, and for casino house, to enhance the incomes and profitability of casino activities, and in particular for casino games.

According to the present invention a method and system is provided for extending the features of an auxiliary game played in conjunction with an underlying casino game to players in addition of players participating in and/or located at the underlying casino game. More particularly, the present invention provides a method and system for controlling and managing bets for a game played remotely from the underlying casino game that permits a player, located remotely from the underlying casino game, to feel enjoyment and socializing atmosphere of a remote underlying casino game; The present invention provides a method and system that permits a player located remotely from the underlying casino game to maintain his principal or primary casino activity, and in same time enjoying intrinsic activity, and feeling the socializing atmosphere of the underlying casino game; The present invention provides a method and system of controlling and managing bets for a remote game that provides additional opportunities of winning prizes in addition of prizes offered by the principal games or auxiliary prizes usually offered to players participating in an underlying casino game; The present invention provides a method and system that provides to casino new sources of profitability in permitting to play a remote game that does not interfere or slow proceedings of the underlying casino game, in offering additional dedication and incentive features to clients or players for participating in casino games, and in permitting possible additional gain entries for casino provided by bets made on the remote game.

Therefore, for achieving these objectives, it has been found that betting operations for players located remotely from the underlying game, have to be simplified. The simplified betting operation being less complex are less demanding in terms of concentration and/or real-time inputs from the player during the proceeding of the underlying game. Consequently, players remotely located from an underlying game are in a better disposition for enjoying the atmosphere, and the intrinsic activity of play of the underlying game or for pursuing another activity at their ease such as drinking at bars, playing at another casino game or simply observing the underlying games.

The betting operation complexity can be distinguished in two types of games.

The first type of games, are games wherein a selection of betting options for play of a game is required during a particular betting period window, and wherein the betting options being applicable for a whole of the play of the game without requiring other real-time input from player during the proceeding of the game, such as roulette games, or dice game such as craps.

A manner to simplify the betting operation is to enlarge the betting period window, and consequently, permitting a remote player to be concentrated on viewing and enjoying the underlying game atmosphere and intrinsic activity and/or alternatively, pursuing another activity without needing to provide real-time input to place a bet in the underlying casino game.

The second type of games, are games requiring multiple betting option decisions during a play of the game, and consequently, these games require real-time inputs from player during the proceeding of a play of the live game, such games as card games as Blackjack, Poker and Baccarat.

A manner to simplify the betting operation for player located remotely from the underlying game, is providing simplified conditions for one or more remote players requiring a selection of betting options being applicable for a whole of the play of the underlying game without requiring real-time input from the remote player, and permitting a remote player to be concentrated on viewing and enjoying the underlying game atmosphere and intrinsic activity and/or alternatively, pursuing another activity without needing to provide real-time input to place a bet in the underlying game.

According to the invention, there is provided a method and system for controlling and managing bets in a gaming environment. The method comprises: receiving a bet request from a player located remotely from an underlying game in the gaming environment; providing a remote view of a play of the underlying game to the player; processing the bet request at a time suitable for the play of the underlying game; determining a payout commensurate with an outcome of the play of the underlying game after the processing; and delivering the payout to the remote player, whereby the remote player can concentrate on viewing the underlying game remotely without needing to provide real-time input to place a bet in the underlying game.

Furthermore, according to the invention, there is provided a second method and system for controlling and managing bets in a gaming environment. The method comprises: playing an underlying game in the gaming environment, the underlying game requiring real-time inputs from players participating in the underlying game during play of the underlying game; providing simplified betting conditions for one or more remote players requiring selection of a betting option for play of the underlying game, the betting option being applicable for a whole of the play of the underlying game without requiring real-time input from the remote players; receiving a bet request from the remote players located remotely from an underlying game in the gaming environment; providing a remote view of a play of the underlying game to the remote players; determining a payout commensurate with an outcome of the play of the underlying game; and delivering the payout to the remote player; whereby the remote players can concentrate on viewing the underlying game remotely without needing to provide real-time input during play of the underlying game.

The present invention provides a method and system for permitting to a larger number of players to participate in a game played in conjunction with an underlying game. Consequently, the present invention further provides for a casino house an opportunity to generate larger and faster jackpot, and a greater flexibility in the number of prizes, the amount of prizes, and the frequency at which the prizes can be awarded to players participating in the remote game played in conjunction with an underlying game. Furthermore, the present invention and system provides to players additional opportunities of winning a larger number of prizes, of higher value, and at an higher frequency rate compared to auxiliary prizes awarded by usual auxiliary games played uniquely by players located at the underlying casino game.

Furthermore, the present invention provides a method and system permitting clients or players in a casino in same time to participate in an remote game and to pursue their principal casino activities such as being at a bar, playing at a gaming machine or participating in a live casino game. The casino house can increase its incomes and enhance profitability of its gaming activities, and particularly, casino games.

Furthermore, the present invention provides a method and system permitting players to participate in a remote game played in conjunction with an underlying casino game from a remote location from the underlying casino game; Consequently, the present invention provides new types and opportunities of wagering on one or a plurality of remote games played in conjunction with one or a plurality of underlying casino games.

Furthermore, the present invention provides a method and system for participating from a plurality of player locations—such as in a casino: at a gaming machine, at a live casino game, at a bar or such as outside of a casino: in an hotel room, at office or in another casino—in a remote game played in conjunction with an underlying casino game.

According to a first broad aspect of the invention, there is provided a system for allowing a remote player to play a live casino table game. A “live casino table game” is understood to mean a betting game that provides action and excitement for players and observers alike, such as blackjack, craps, roulette, poker, baccarat, and the like, whether in manual, electronic or mixed manual/electronic form. The system according to the first broad aspect of the invention comprises a live casino table game interface for collecting live play data about a play of the table game, a player console located away from the live casino table game for collecting bet data from a remote player, a game controller connected to the player console and to the game interface for collecting the bet data and the live play data to credit and debit an account of the remote player as a function of wins and losses according to rules of play, and a video system providing a video display of the live casino table game to the remote player. The game controller determines from the live play data when further bets may not be accepted for the current play of the table game and interacts with the remote player via the player console to confirm whether the bet data received from the remote player should be applied to a subsequent game. In this way, the remote player plays the live casino table game remotely at a same rate and rhythm as players at the live casino table game. Preferably, the live casino table game is a manual game. The player console may randomly select the bet data from a set of predetermined betting options.

According to a second broad aspect of the invention, there is provided a system for allowing a remote player to play a live casino table game having a live casino table game interface for collecting live play data about a play of the table game, a player console located away from the live casino table game for collecting bet data from a remote player, a game controller connected to the player console and to the game interface for collecting the bet data and the live play data to credit and debit an account of the remote player as a function of wins and losses according to rules of play, and a video system providing a video display of the live casino table game to the remote player. According to this second aspect, the live play data includes game play data of at least one of the players and the dealer playing the live casino table game, and the bet data defines a simplified betting option including a game achievement status of a player or dealer involved in the live casino table game. The game achievement status may be a win/lose status for each play of the live casino table game. The game controller may calculate odds for the simplified betting option as a function of the live play data. Preferably, the simplified betting option is maintained automatically for a plurality of plays of the live casino table game.

According to a third broad aspect of the invention, there is provided a system for allowing a remote player to play a live casino table game having a live casino table game interface for collecting live play data about a play of the table game, a player console located away from the live casino table game for collecting bet data from a remote player, a game controller connected to the player console and to the game interface for collecting the bet data and the live play data to credit and debit an account of the remote player as a function of wins and losses according to rules of play, and a video system providing a video display of the live casino table game to the remote player. According to this third aspect, the video system comprises a display screen installed for viewing by a plurality of remote players, and the system comprises a player console for each of the plurality of remote players for collecting the bet data and controlling the remote player's account, while relying on the display screen to provide the video display of the live casino table game. The player console may be portable, whereby the console may be provided in a lounge or restaurant. Preferably, the player console is wireless. The player console may advantageously provide the remote player with a choice of one of a plurality of the live casino table game for which the bet data is to apply.

The game controller may also determine a random virtual event and credits the account of the remote player as a function of the random virtual event determines the remote player.

The live casino table game may be a roulette game, and the live casino table game interface may interface with the roulette game. Likewise, the live casino table game may be a card game, and the live casino table game may interface with the card game.

According to a further broad aspect of the present invention, there is provided a method of processing bet data in a system allowing a remote player to play a live casino table game, the system comprising a live casino table game interface for collecting live play data about a play of the table game, a player console located away from the live casino table game for collecting bet data from a remote player, a game controller connected to the player console and to the game interface for collecting the bet data and the live play data to credit and debit an account of the remote player as a function of wins and losses according to rules of play, and a video system providing a video display of the live casino table game to the remote player. The method comprises determining from the live play data when further bets may not be accepted for the current play of the table game, interacting with the remote player to confirm whether the bet data received from the remote player should be applied to a subsequent game, and applying the bet data to the subsequent game when confirmed. In this way, the remote player plays the live casino table game remotely at a same rate and rhythm as players at the live casino table game.

### BRIEF DESCRIPTION OF DRAWINGS

These and other features, aspects and advantages of the present invention will become better understood with regard to the following description and accompanying drawings wherein:

FIG. 1 is a schematic representation of the system according to a preferred embodiment of the present invention;

FIG. 2 is a schematic representation of the game controller according to a preferred embodiment of the present invention;

FIGS. 3A, 3B and 3C are combined to form a schematic view and representation of the system according to a preferred embodiment of the present invention;

FIG. 4 is a block diagram of the apparatuses for creating a player credit account according to a preferred embodiment of the present invention;

FIG. 5 is a block diagram of the system according to a preferred embodiment of the present invention;

FIG. 6 is schematic representation of a remote player console according to a preferred embodiment of the present invention;

FIG. 7 is a flowchart representing the steps of the method of the present invention;

FIGS. 8A and 8B are combined to form a flowchart representing the steps and one method according to a preferred embodiment of the present invention.

### DETAILED DESCRIPTION OF THE PREFERRED EMBODIMENTS

According to a preferred embodiment, the structure of the bet control and management system will be described.

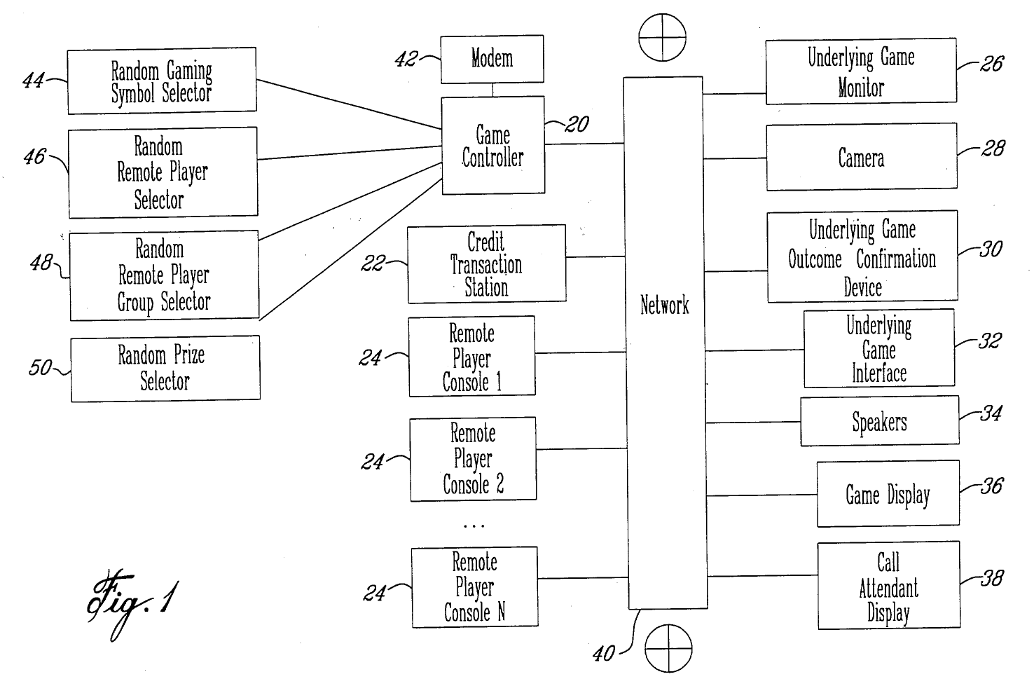

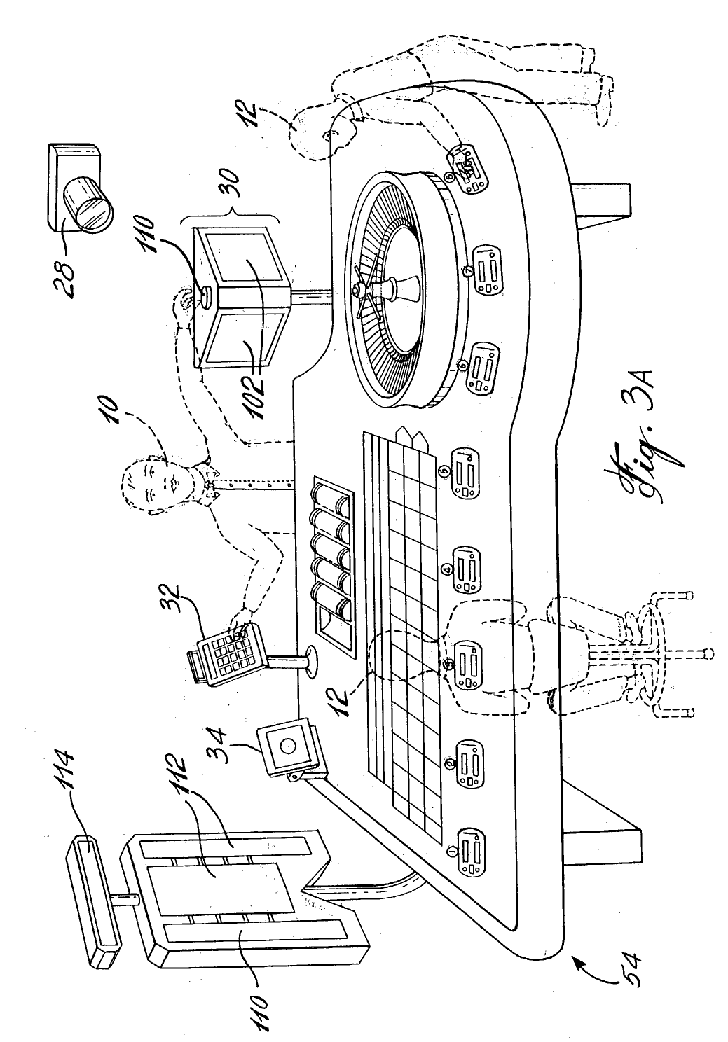

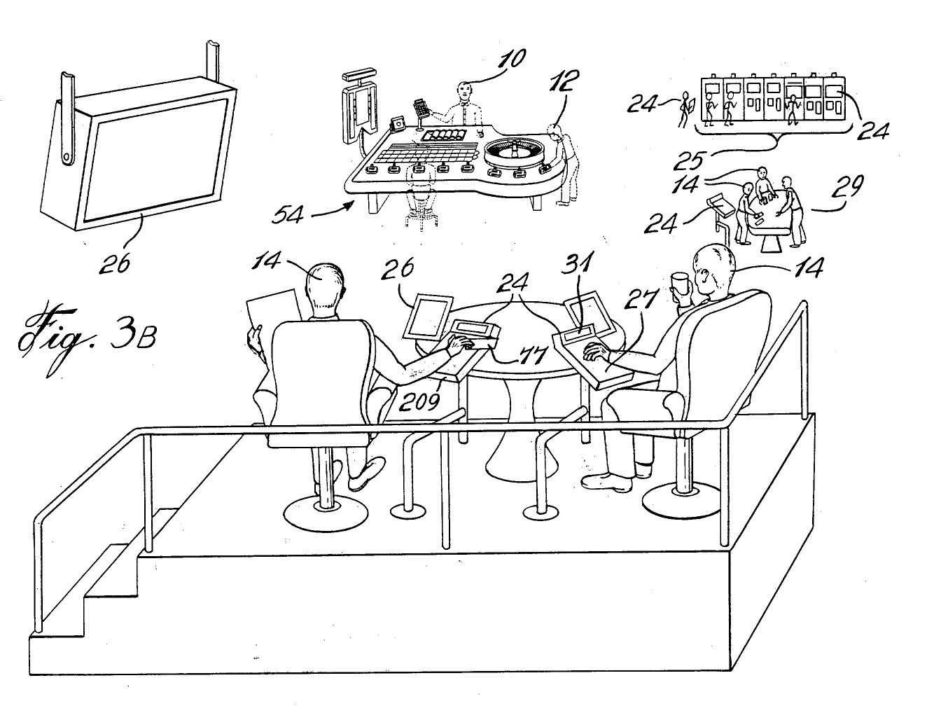

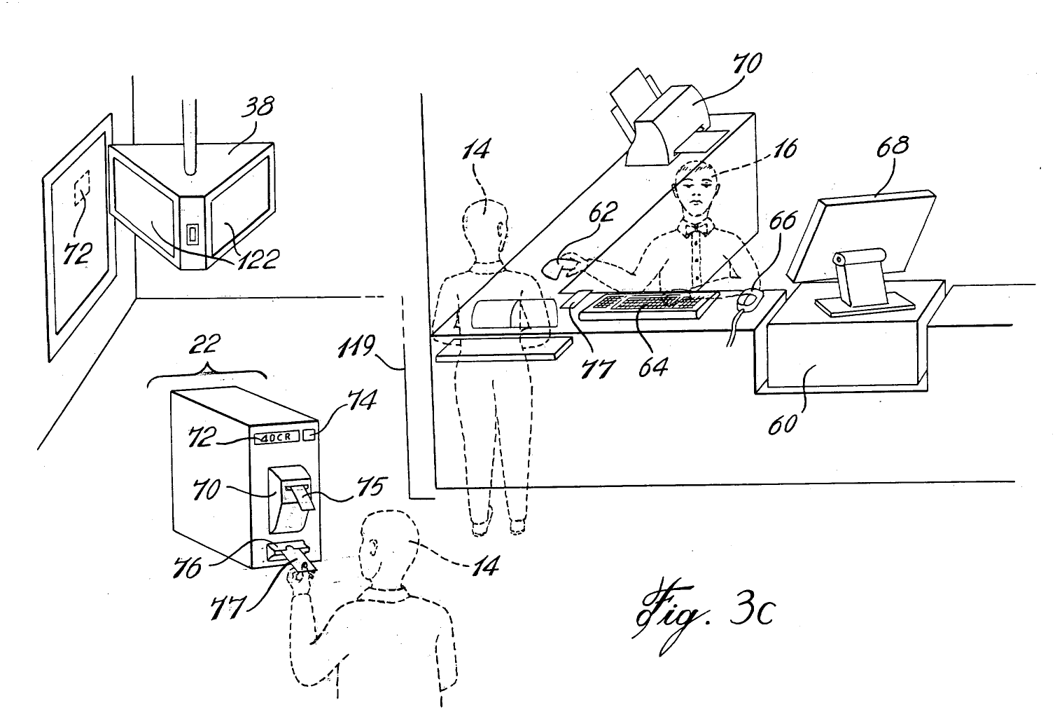

As shown in FIG. 1, FIG. 3A, FIG. 3B and FIG. 3C, the system of the present invention according to a preferred embodiment provides a game controller 20, a credit transaction station 22, a plurality of player consoles 24, an underlying game monitor 26, a camera 28, an underlying game outcome confirmation device 30, an underlying game interface 32, speakers 34, a game display 36 and a call attendant display 38. A network ensures communication among the different units of the system, in the present preferred embodiment, a RS 485 network 40 is used.

According to a preferred embodiment of the present invention, there is provided at least one game controller 20, which is connected to each remote player console 24. The game controller 20 controls and manages bets and information between the different units of the system. The game controller 20 is connected to four random selectors: a random gaming symbol selector 44, a random remote player selector 46, a random remote player group selector 48 and random prize selector 50. A modem 42 is connected to the game controller 20 permitting to operate the game controller 20 from a remote location or to communicate with other game controllers 20.

A random gaming symbol selector 44 includes a random number generator picking gaming symbols from virtual set of gaming symbols related to the underlying casino game 54. The random gaming symbol selector 44 generates a value representing a set of gaming symbols related to the underlying casino game.

A random remote player selector 46 includes a computer random generator (as is known in the computing art) for generating at random a value representing one of players located at a remote player console 24 either assuming there may be a remote player 14 occupying each remote player console 24, or taking into account which remote player consoles 24 are effectively occupied by a player 14 participating in the game played remotely from the underlying casino game.

A random remote player group selector 48, includes a computer random number generator (as is known in the computing art) for generating at random a value representing a group of remote player positions at remote player console 24, either assuming there may be a player at all remote player consoles 24 of each group or taking into account groups of remote player consoles 24 for which at least one remote player console 24 is occupied by a remote player 14.

A random prize selector 50 includes a computer random generator for generating at random a value representing a prize. The prize could be tangible as a car, a voyage, etc. or a monetary value amount.

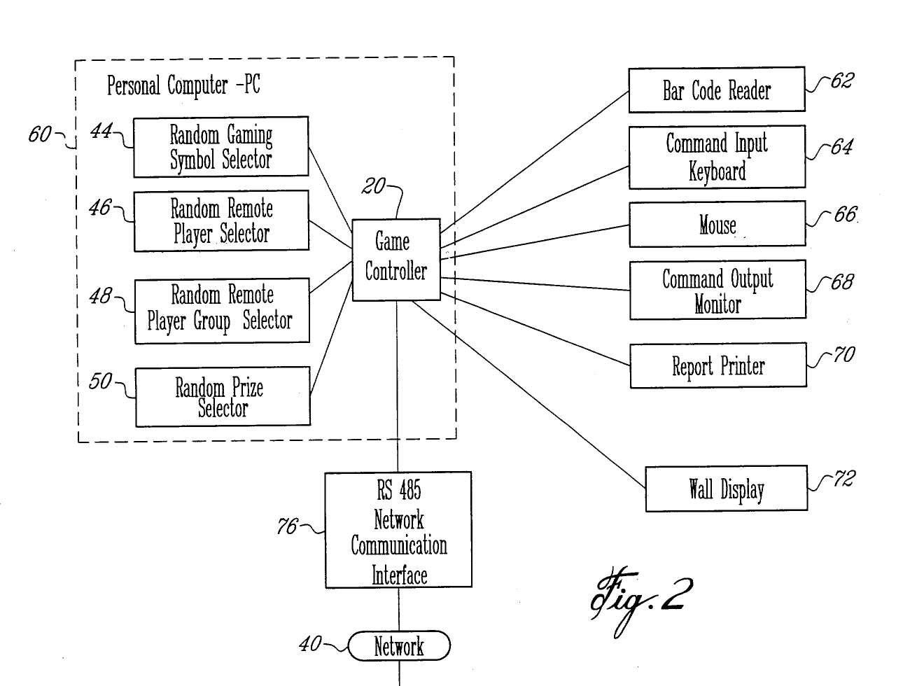

As it can be appreciated and as shown in FIG. 2 and FIG. 3C, game controller 20, random gaming symbol selector 44, random remote player selector 46, random remote player group selector 48 and random prize selector 50, could be integrated into a personal computer (PC) 60 provided with a communication interface 76 for communication with the plurality of units interconnected to the game controller 20.

In the present preferred embodiment, the personal computer (PC) 60 contained programs necessary to run the system of the present invention. Furthermore, a code bar reader 62, a command input keyboard 64, a mouse 66, a command output monitor 68, a report printer 70 and wall display 72 are connected to the personal computer 60.

The RS 485 network communication interface 76 insures the communication between the personal computer (PC) 60 and the RS 485 network 40.

Referring to FIG. 1 and FIG. 3C, a credit transaction station 22 permit players to obtain credits to play to the remote game. In the present preferred embodiment, the credit transaction station 22 can be located at plurality locations inside or outside the casino

As shown in FIG. 1 and FIG. 3B, the invention provides a plurality of remote player consoles 24. Each remote player console 24 permits a player located remotely from an underlying casino game 54 to participate in a game played in conjunction with the underlying game 54.

As shown in FIG. 3B, the remote player consoles 24 are installed in manner to provide a view of the underlying game 54 to remote players 14. Remote players 14 can enjoy the atmosphere and intrinsic activity of play of the underlying game and to pursue at their ease another activity such as drinking at bars, playing another casino game or simply observing the underlying game. Some player consoles 24 are located in a manner to permit a direct view on the underlying game 54. For example, as shown in FIG. 3B, the consoles 24 on a gallery 27 or besides the underlying game 54 provides a direct view on the underlying game 54. Other remote player consoles 24 are located besides or near an underlying game monitor 26 permitting remote players 14 to view the underlying game 54. Some game underlying monitors 26 are associated with a unique remote player console 24. Player consoles 24 can be located besides gaming machines or integrated into gaming machines 25, at a bar, besides casino game table 29 or on another casino table game.

Referring to FIG. 1 and FIG. 3A, the system provides a camera 28 focusing on the underlying casino game 54 in order to provide video and VGA signals to the underlying game monitors 26. The camera 28 is connected to game controller 20, which is connected to underlying game monitors 26. The camera 28 sends in real-time signal to underlying game monitors 26. The underlying game monitors 26 transmit in real-time the activity, and the atmosphere of the underlying live casino game 54 to a remote location from the underlying casino game 54.

In the present preferred embodiment, as shown in FIG. 3A, an underlying game interface 32 is connected via a network 40 to the game controller 20. The dealer 10 responsible at the underlying casino game 54 inputs, using an underlying game interface 32, namely the betting period signal for the remote game played in conjunction with the underlying casino game 54 in progress, and some outcomes of play produced by the underlying casino game 54.

An underlying game outcome confirmation device 30 is connected to game controller 20 via a network 40. The game outcome confirmation device 30 comprises a switch 100 and displays 102. Once an outcome of the underlying game is entered into the underlying game interface 32, the outcome entered is displayed on displays 102 in order to obtain a second check by dealer 10 or players 12. If the underlying game outcome displayed on the displays 102 corresponds to the real outcome of the play of the underlying game 54, the game outcome confirmation device switch 100 is activated by the dealer 10, players 12 or other individuals. Then the outcome value is sent via network 40 and registered into a memory of the game controller 20.

It will be appreciated that the interface 32 collects the necessary data to resolve outcomes according to the rules of the remote game. In one embodiment, remote players can bet on a player at the underlying live casino table game. In this case, the game controller 20 must resolve the payout as a function of the data received from the interface. In the specific case of roulette, a player is identified by token or chip color, and the amount bet and the amount won values are required to calculate the payout. Since players can place chips at various locations on the board, exact wins and losses are not as relevant and the overall payout.

Betting on a player at the underlying game allows a remote player to focus his or her attention on the video image of the game, like any other observer on the casino floor while enjoying the comfort of being at home, in a bar, in a restaurant or in a hotel room. Whether the video at the live game includes images of peoples' faces at the table is a design choice. It is simple to have one or more camera angles, such as a single overhead view that preserves the privacy of the players standing or seated around the table. Notice that the cameras are present can be provided to warn local players of the possible breach of or encroachment on their privacy. Furthermore, with the proper notice and acceptance of terms, direct views of the players may also be provided by the video connection to the remote players.

As shown in FIG. 1 and FIG. 3A, a speaker 34 is connected to the game controller 20 via network 40. The speakers 34 provides sounds, tunes or other messages for entertaining players 12, 14 and to give some information about the underlying game and its processing.

In referring to FIG. 1 and FIG. 3A, according to the present preferred embodiment, a game display 36 is connected via a network 40 to the game controller 20. The game display 36 comprises an underlying game outcome display 110 that displays underlying game outcomes, a random selection result display 112 that displays the randomly selected results, and a message display 114 for displaying game information, jackpot value and prizes.

In referring to FIG. 1 and FIG. 3C, a call attendant display 38 is connected to game controller 20 for displaying identification of a remote player console 24. The remote player console identification displayed on call attendant displays 122 communicates to casino employees which console where a player requires the help of an attendant.

In another preferred embodiment, of course, as it is known in the art, the communications link or network can comprises a wireless communication link between units of the present system.

Furthermore, it will be understood that a game controller 20 could be in communication with a plurality of underlying game interfaces 32 providing to players a plurality of remote games played in conjunction with a plurality of underlying games.

It will be also understood that the game controller 20 can be alternatively integrated with the remote player console 24 or with the underlying game interface 32.

Now, how the present invention of a method and system for controlling and managing bets in a gaming environment operates and can be used according to a preferred embodiment will be described.

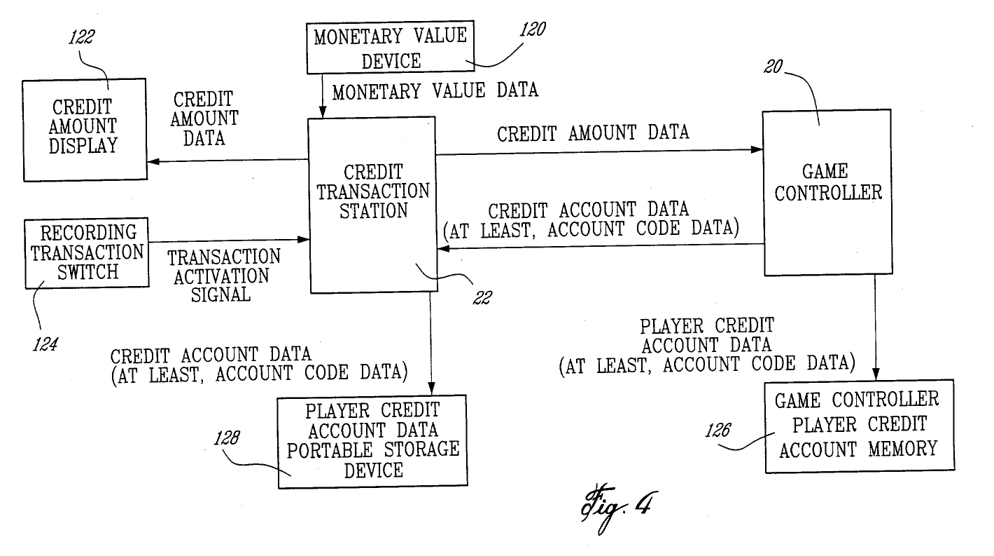

Now, referring to FIG. 4 which is a block diagram of the apparatuses for creating a player credit account according to a preferred embodiment and according to the present preferred embodiment, a player must obtain a player credit account before to be able to participate in a remote game.

In referring to FIG. 4 a player credit account is created by the insertion of appropriate monetary value device 120 into the acceptor of the credit transaction station 22. The acceptor reads the monetary value devices 120 and converts the value monetary amount into a credit value amount. A credit value amount display 122 displays the corresponding credit value amount. The player 14 inserts monetary value devices 120 until the monetary value amount displayed corresponds to the desired credit value amount. The monetary value device 120 could be coins, tokens, bills, or credit cards.

When the desired credit value amount is reached, the player 14 activates a recording transaction switch 124. The activated switch 124 provides a signal to the credit transaction station 22 which communicates to the game controller 20 the credit amount data. Upon reception of the credit amount data signal, the game controller 20 creates and encodes a new credit player account. The game controller 20 stores the player credit account code into a player account memory 126 in communication with the game controller 20. The credit account amount corresponding to the new player credit account is stored into a memory. The player account amount memory 126 could be a portable data storage device 128 as a smart card or a magnetic card or the player account amount memory could be a fixed memory 126 in communication with the game controller 20. In the case where the player credit account amount is stored onto a portable data memory 128, the game controller 20 communicates to the credit transaction station 22 the credit account data comprising the amount of credits of the player account and the code of the encoded player account. In the case where the player credit account amount is stored into a fixed memory 126 in communication with the game controller 20, the game controller 20 communicates to the credit transaction station 22 credit account data comprising the code of the encoded player credit account.

Upon reception of the credit account data, the credit transaction station 22 stores the appropriate account data upon the appropriate support. For example, the player account code and the credit account amount could be stored onto a smart card or a magnetic card. The player account code could be stored onto a smart card, a magnetic card, a bar code ticket etc. . . .

Now referring back to FIG. 3C, in a preferred embodiment, the system provides a credit transaction station 22 which permits players to buy credits for playing a game played remotely from where the underlying game 54 is played. The credit transaction station 22 connected to a game controller 20, comprises a bill acceptor 70, a credit amount display 72, a credit ticket distributor 76, and a recording transaction switch 74. To buy credits, a player 14 inserts a bill 75 into a bill acceptor 77. The value in credits of the bill 75 inserted, and read by the bill acceptor 70, is displayed on the credit amount display 72. A player 14 inserts bills 75 until the credit display 72 displays the amount of credits that a player 14 wants to buy. When the desired credit amount is displayed on the credit amount display 72, the player 14 activates the recording transaction switch 74 to signal game controller 20 to register the credit transaction. The game controller 20 creates a new player credit account, identified the new credit account with a bar code, registers the code and the amount of bought credits into the player credit account memory 126 in communication with the game controller 20. The game controller 20 communicates the credit account data to the credit transaction station 22. The credit account data comprises the code of the encoded player account. The credit ticket distributor 76 delivers to the player a bar code ticket 77 wherein the bar code identifies the player credit account registered into the game controller player credit account memory 126 connected with the game controller 20. In the preferred embodiment, the player account memory is integrated into the game controller 20.

A remote player console 24 must have access to a player credit account in order to permit a player to bet and participate in games played in conjunction and remotely from one or many underlying games 54.

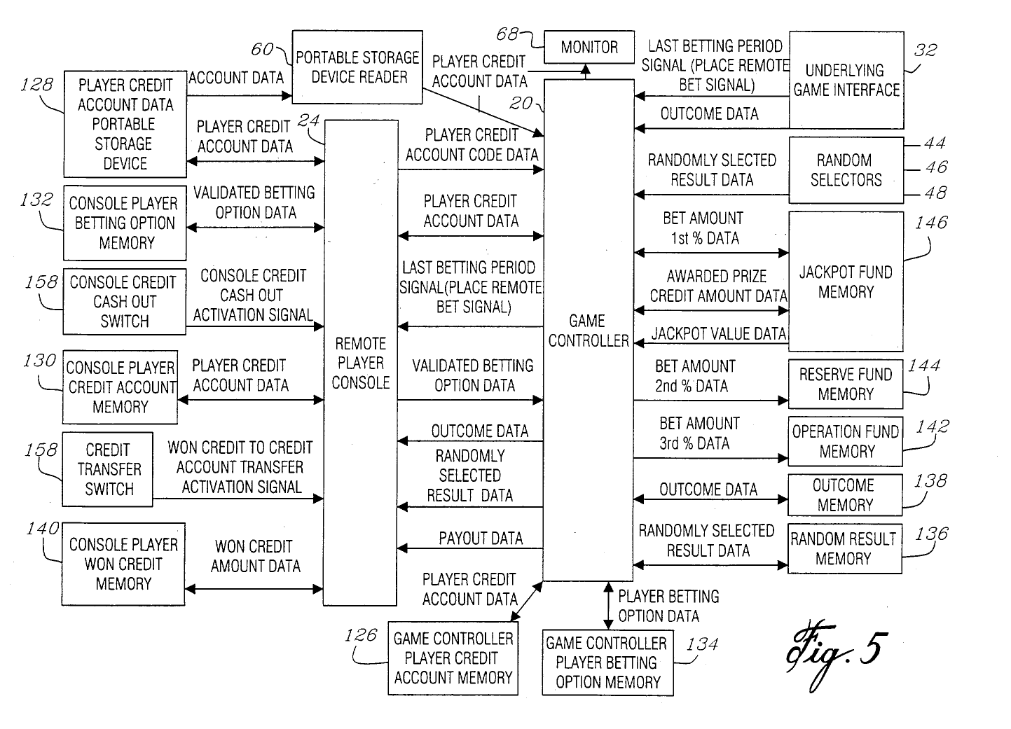

Now referring to FIG. 5, which is a block diagram of the system according to a preferred embodiment of the present invention, how the present invention of a method and system operates and is used according to the present embodiment will be described.

In the case where the player credit account amount is stored into a portable storage device 128, such as a smart card or a magnetic card, the player introduced the portable storage device 128 into the portable storage reader of the remote player console 24. Once the reader of the player console 24 has read the player account code and amount stored into the portable storage device 128, the remote player console 24 communicates to game controller 20 the player credit account code data.

In the case where the remote player account amount is stored into a fixed player credit account memory 126 in communication with the game controller 20, the player 14 has to transfer the player credit account amount into the remote player console player account memory 130. An appropriate remote player console reader reads the player credit account portable storage device 128 that stores the credit account code. Once the reader of the player console 24 has read the player account code and amount stored into the portable storage device 128, the remote player console 24 communicates to game controller 20 the player credit account code data.

As known in the art, portable storage devices 128 used to store the credit player account amount and credit player account code could be, for example, smart card or magnetic card. Furthermore, portable storage devices 128 can be used for storing or registering the identification code of the player credit account, such as, for example, a smart card, a magnetic card or a bar code ticket.

Upon reception of player credit account code data, the game controller 20 compares the credit account code data received with player credit account codes stored in a player credit account memory 126 connected to the game controller 20. If the player credit account code corresponds to a player account code stored into the game controller player account memory 126, the game controller 20 validates the player account code and sends to the remote player console 24 player credit account validated code data. Otherwise, the remote player console 24 stays inactive. Furthermore, in the case where the remote player account amount is stored into a fixed player credit account memory 126 in communication with the game controller 20, the game controller 20 transfers the corresponding player credit account amount into a console player account memory 130 in communication with the remote player console 24.

Upon reception of the account code validated data from the game controller 20, the remote player console 24 activates its betting option interface and displays the player credit account amount on a display of the remote player console 24.

As it can be appreciated, different embodiments can perform the operations and functions of the remote player credit account transaction. Of course, the manner for buying and/or transferring credits into a remote player console 24 can take other embodiments. For example, each remote player console 24 connected to the game controller 20, could be provided with an integrated credit transaction station 22.

In the present preferred embodiment, the portable storage device 128 is a bar code ticket 77 where on the bar code identifies a player credit account. Once the remote player console 24 reads the bar code stored into the bar code ticket 77, player credit account code data are sent to the game controller 20. The game controller 20 compares the credit account code data received with player credit account codes stored in a player credit account memory 126 connected to the game controller 20. If the player credit account code corresponds to a player account code stored into the game controller player account memory 126, the game controller 20 validates the player account code and sends to the remote player console 24 player credit account validated code data. Otherwise, the remote player console 24 stays inactive. In addition, the game controller 20 transfers the corresponding player credit account amount into a console player account memory 130 in communication with the remote player console 24.

The activated betting option interface of the remote player console 24, offers one or more sets of betting options on a same underlying game 54 or on a plurality of underlying casino games. The betting option interface of the remote player console 24 can take a plurality of embodiments. For example, the betting option interface could be a touch-screen or an electronic switchboard.

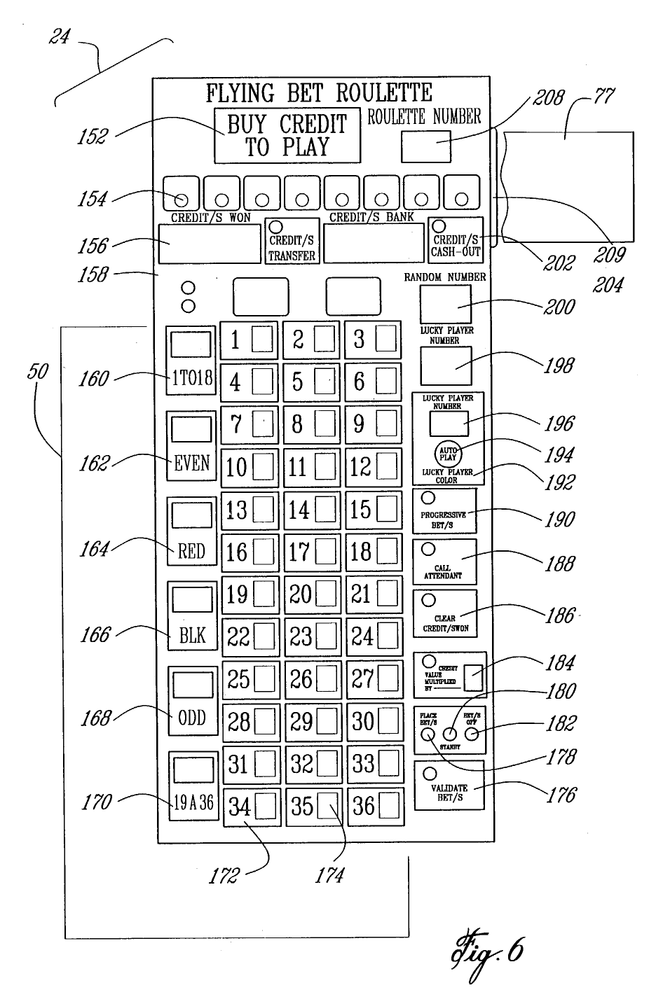

In referring to FIG. 6 which is a schematic representation of a remote player console 24 according to a preferred embodiment of the present invention, a description of a remote player console 24 according to the present embodiment follows.

According to the present preferred embodiment, the remote player console 24 is adapted for participating in a remote game played in conjunction with an underlying roulette game 54.

In a preferred embodiment, a message like “BUY CREDITS TO PLAY” is displayed on a information and instruction display 152 indicates that the remote player console 24 is available, and invites a player 14 to participate in a game played in conjunction with an underlying live game played remotely. In the present preferred embodiment, the information and instruction display 152 is a liquid crystal display (LCD). In the present preferred embodiment, the underlying game is a roulette game.

According to the present preferred embodiment, the remote player console 24 provides a bar code reader 209. The bar code reader 209 permits players to transfer credit account amount into the remote player console credit account memory 130 in communication with the remote player console 24. In the present preferred embodiment, the remote player console credit account memory 130 is integrated into the remote player console 24.

According to the present preferred embodiment, the remote player console 24 provides a credit bank display 204. The credit bank display 204 displays the player credit account amount transferred into the player credit account memory 130 of the player console 24. The credit bank display 204 displays the amount of credits available for betting.

According to the present preferred embodiment, the remote player console 24 provides a bet selection interface 150. In the present preferred embodiment, a plurality of switches 160-174 permits a player 14 to select and wager on remote game betting options. As it will be understood, the remote betting options can take a plurality of embodiments in function of the underlying game, and the type of betting options offered.

According to the present preferred embodiment, the remote player console 24 provides a validate bet/s switch 176. When the validate bet/s switch 176 is activated, betting options selected by the player 14, are stored into a player betting option memory 132 in communication with the remote player console 24. In the present preferred embodiment, the console player betting option memory 132 is integrated into the remote player console 24.

In another preferred embodiment, a player account is stored into a portable data storage device in communication with the remote player console 24. By example, such portable data storage device can be a smart card or magnetic card. In addition of player account, some preferred betting options of a player could be stored into a portable data storage device. Then instead of using a bar code ticket 77, a magnetic card or a smart card can be used with an appropriate reader means, as known in the art, associated to the remote player console 24.

In the present preferred embodiment, the remote player console 24 provides a betting option set switch 190 permitting a player to pass from a set of remote game betting options to another set of remote game betting options.

In the present embodiment, two sets of betting options on a same underlying game are provided. The first set of betting options is a subgroup of typical roulette game betting options. Namely, the remote betting options available are: “Straight up” bet 172 on a number among 1 to 36, 0, 00; bet on the parity: “Odd” 168 or “Even” 162; bet on a color; “Red” 164 or “Black” 166; bet on a numerical range: “1 to 18” 160 and “19 to 36” 170.

The second set of betting options is restricted only on a combination of one or many numbers among 1 to 36, 0, and 00.

According to a preferred embodiment, each remote player console 24 is identified uniquely by an indication, and a group of remote player consoles is identified by another indication. In a preferred embodiment, a number and a color identify each console. In the present preferred embodiment, the number 196 identify uniquely each remote player console 24, and the color 192 identifies a group of remote player consoles 24 identified with a same color.

According to a preferred embodiment, the remote player console 24 provides a display 152 for displaying to players game instructions and information and a display 208 which displays outcomes of play of the underlying live casino game. The remote player console 24 provides also displays 198, 154, 200 which display results of predetermined virtual events produced by random selectors, respectively: random remote player selector 46, random remote player group selector 48, and random gaming symbol selector 44.

In the present preferred embodiment, the remote player console 24 provides a clear all bets switch 186 permitting a player to cancel his or her previous betting options identified.

According to the present preferred embodiment, the remote player console 24 provides: a credit won display 156. The credit won display 156 displays the amount of accumulated won credits stored into the remote player console won credit memory 140. According to the present preferred embodiment, a credit transfer switch 158 permits a player to transfer won credits from the console won credit memory 140 to the console credit account memory 130. The remote player console provides also a credit cash out switch 202, permitting a player to transfer his credits from the console credit account memory 130 to the game controller player credit account memory 126.

Furthermore, according to a preferred embodiment, the remote player console 24, provides an auto-play switch 194, permitting players to register in advance preferred betting options which betting options will be wagered automatically until some predetermined parameters are reached. The remote player console 24 in auto-play mode participates automatically in a number of successive remote games without requiring any real-time input from a player. The betting options are stored into a betting option memory 132 in communication with the remote player console 24. Of course, the preferred betting options memory 132 could be stored into portable device storage or into a memory integrated with the remote player console 24. In the present preferred embodiment, the preferred betting memory 132 is integrated into the remote player console 24.

According to the present preferred embodiment, the auto-play switch 194 when activated, permits a player to maintain automatically his participation in one or a plurality of successive remote games without needs of any real-time inputs from the player into the corresponding remote player console 24. When the player has validated betting options, he activates the auto-play switch or button 194. At this time a message is displayed on the display 152 indicating to the player to present his bar code ticket 77 to the bar code reader 209, associated to the remote player console 24. Once the bar code ticket 77 is read, the player enters on the remote player console 24, the parameters determining the end of the automatic participation in a number of remote games. The parameters can be i) a predetermined amount of credits won stored into the console credit won memory 140; ii) a predetermined amount of credits stored into the console credit account memory 130; iii) a predetermined number of games played automatically; iv) a predetermined period of time; or v) any combination of the previous parameters.

In the present preferred embodiment, instructions for entering values of the autoplay parameters are displayed on the instruction and information display 152. In the present preferred embodiment, upon the instruction displayed on the console display 152, some switches of the remote console 24 are identified, and used for entering values of auto-play parameters. Once the values of auto-play parameters have been entered, the remote player console 24 participates automatically. Once the remote player console 24 is set to participate automatically in one or a plurality of remote games i.e. in an auto-play mode, no one can use the remote player console 24 until the parameter values have been reached, or the auto-play mode has been deactivated by the player or by an employee of the casino. To deactivate the auto-play mode, the same bar code ticket 77 that has been used to set the auto-play mode, must be read again by the bar code reading means 209 associated to the remote player console 24.

According to the preferred embodiment, the remote player console provides a switch identified as a “credit value multiplied by” switch 184. In using the “credit value multiplied by” switch 184, a player decides the credit value of a credit unit that he wants to bet.

According to the preferred embodiment, the credit amount wagered is subtracted automatically from the console credit account amount stored into the console player account memory 130, and the credit bank display 204 displays the new credit amounts available in the console player credit account memory 130.

The betting period available to a player to make his wagers is indicated by visual indication means. In the present preferred embodiment, three color lights 178, 180, 182 indicate different moments of betting period. The activated green light “Place Bet/s” 178 indicates to remote players 14 that remote bets on the present or next remote games can still be recorded. The activated yellow light “Standby” 180 indicates to players 14 that the last period to bet on the present remote game in progress is running. Finally, when the red light “Bet/s Off” 182 is activated that indicates that no more bets are accepted on the present remote game.

As long as the green light is activated 178, or the yellow light is activated 180, the player selects his betting options. Finally, the player 14 validates in activating the “Validate Bet/s” switch 176.

In order to refund all credits from a console 24 to a remote player credit account stored into the game controller 24, the player activates the “clear all bets” switch 186, and the credit transfer switch 158 in order to bring back all available credits into the player credit account stored into the console credit account memory 130. The total amount of credits of the credit account is displayed on the credit bank display 204. To initiate the transfer, a player activates the credit cash out switch 202, and inserts his bar code ticket 77 into the console bar code reader 209. The total amount of credits displayed on the credit bank display 204 is then transferred into the game controller player credit account memory 126 corresponding to the credit account identifies by the code encoded on the bar code ticket 77. When the transfer is completed, a zero credit value is displayed on the credit bank display 204.

In a preferred embodiment, the remote player console 24 provides a call attendant switch 188, permitting to signal to a casino employee that his presence and/or help is required by a player playing at the remote player console 24 indicated on the call attendant display 38. When the call attendant switch 188 of a remote player console 24 is activated, a signal is transmitted via game controller 24 to a call attendant display 38 that displays the corresponding remote player console 24 identification 196 in order to advise an attendant that a player 14 at the identified remote player console 24 required his presence, and help of an attendant.

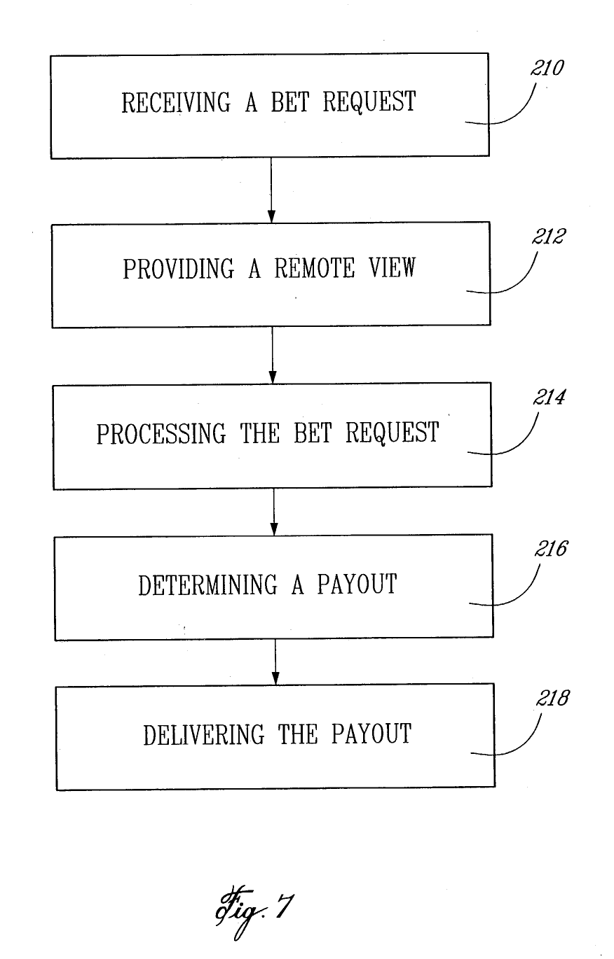

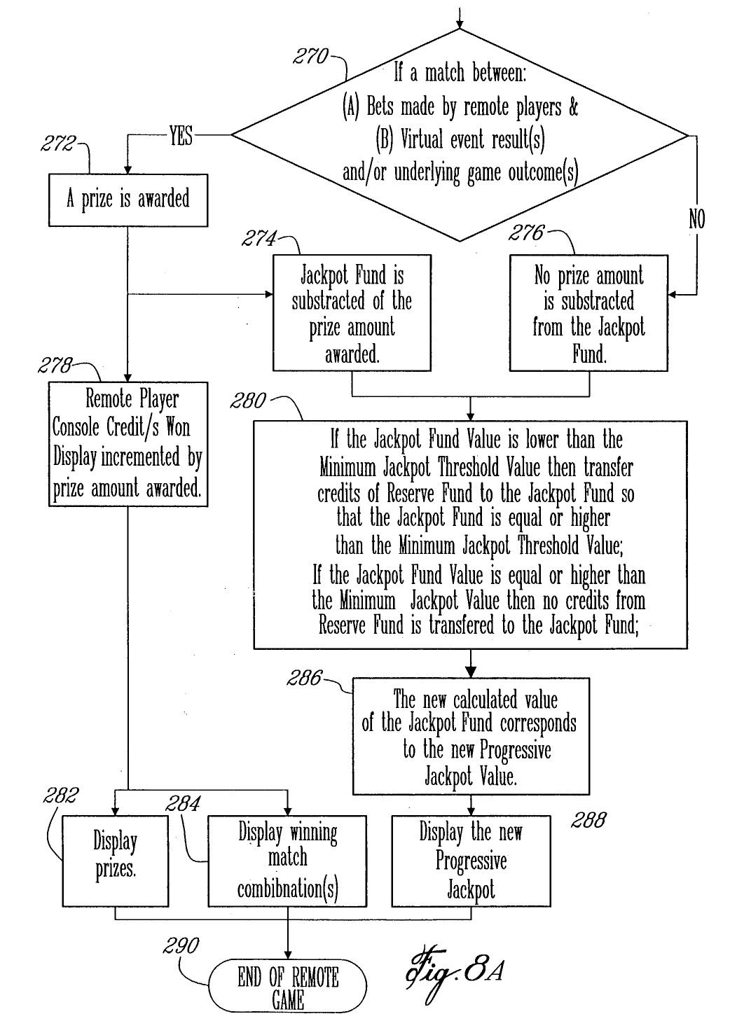

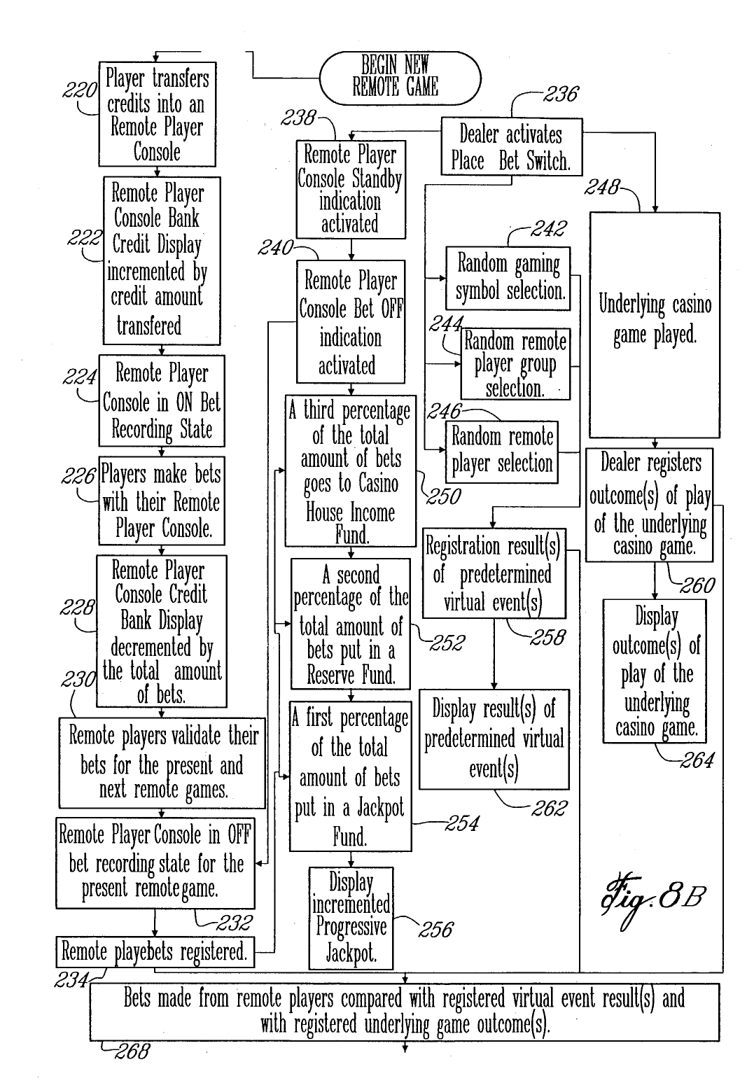

In referring to FIG. 5, FIG. 7, FIG. 8A and FIG. 8B, how to play a game played remotely from where is played an underlying game and to use the method and the system of the present invention, according to a preferred embodiment, will be described.

FIG. 5 is a block diagram of the system according to a preferred embodiment of the present invention. FIG. 7 is a flow chart representing the steps of the method of the present invention. FIG. 8A and FIG. 8B are joined to form a flowchart, which represents the steps and one method according to one method according to a preferred embodiment of the present invention.

In referring to FIG. 7, the method of the present invention comprises the step of receiving a bet 210.

The remote player console 24 must have access to the player credit account in order to permit the player to bet and participate in games played in conjunction and remotely from one or many underlying games.

In a preferred embodiment, player credit account amount must be transferred into a player credit account memory 130 in communication with the remote player console 220. In the present preferred embodiment, a bar code ticket 77 is scanned by a bar code reader 209 integrated into the remote player console 24. When the bar code of the bar code ticket 77 has been read, the remote player console 24 sends a remote player credit account code signal to the game controller 20. The game controller compares the player credit account code with player credit account codes stored into the player credit account memory 126 in communication with the game controller 20. If the player credit account code corresponds to a player credit account code among player credit account codes stored into the game controller player credit account memory 126, the game controller 20 validates the player credit account code. Upon validation of the player account code, the game controller 20 sends the player credit account amount data to the player account memory 130 of the corresponding remote player console 24. If the player account code is invalidated, the remote player console 24 stays inactive.

According to the present preferred embodiment, the bar code reader 209 is associated with a guided sliding bar code ticket inserting means in order to enhance the rapidity of the operation in permitting in a first attempt to obtain a correct positioning of the ticket bar code and the bar code reader 209, facilitating and enhancing the bar code reading operation for the player 14.

The remote player console bank credit display 204 displays an amount of credits incremented by the credit amount transferred 222. The credit amount transferred into a credit account memory 130 in communication with a remote player console 24 appears on the credit bank display 204 of the corresponding remote player console 24. The betting option interface 150 is activated. The remote player console is in ON recording state 224. In the present preferred embodiment, a “place bet” indicator 178 activated indicates that a player can make his remote betting options for the present or next remote games played in conjunction with one or many underlying casino games. In the present preferred embodiment, a visual indication is activated, indicating to the player that the remote player console is in ON remote bet recording state. In the present embodiment the visual indication is a green LED.

The players make bets with their remote player consoles 226. In preferred embodiments, the remote player console 24 offers one or many set of betting panels associated to one or many underlying casino games. The betting interface can take many embodiments such as a touch-screen or a switchboard.

According to the present invention, two ways have been developed for simplifying the betting option operation of players 14 remotely located from an underlying game, making remote players 14 in better dispositions for enjoying the atmosphere, and the intrinsic activity of play of the underlying game or pursuing another activity at their ease.

The first way is enlarging the betting window compared with the betting window of the underlying game.

The second way is providing set of betting options applicable for a whole of the play of the underlying game.

Typically, an underlying game is composed of four periods: a betting period, a random process period—where random processes take place and where one or many gaming symbols are randomly selected or distributed—a win and loss resolution period where the game outcomes are compared with the gaming symbols possessed or chosen by the players 12, and a reordering period wherein, the dealer 10 prepares the game table for the next game.

In the present embodiment, the betting window is larger compared to the underlying game betting period. The betting period for a player participating to the underlying game with a remote player console 24 starts from the end of the random process of the previous play of the game and goes to the end of the betting period of the present play of the underlying game. The player 12 participating in and located at the underlying game can bet only during the betting period of the present play of the underlying game.

Furthermore, in the present embodiment, the remote player console 24 permits a player to set his remote player console 24 into an automatic participation mode. The player selects a number of betting options for one or a plurality of successive games. The remote console 24 stores the selected betting options into a player betting option memory 132 in communication with the remote player console 24. When the player activates the automatic participation mode of the remote console 24, no needs of any real-time inputs are required by the player during the play of one or the plurality of underlying games selected. The player betting options stored are processed for each play of the underlying game. Furthermore, the player betting options could be stored into a portable storage device such as a smart card or a magnetic card. In the present preferred embodiment, the player betting options are stored into the betting option memory 132 integrated into the remote player console 24.

Different parameters can determine the end of the automatic participation mode. For example, the parameters could be: a predetermined amount of credits won stored into a won credit memory 140; a predetermined credit amount stored into the credit player account memory 130; a number of games played automatically; a predetermined period of time; or any combination of the previous parameters. In the present embodiment, the console credit account memory 130 and the won credit memory 140 are integrated into the remote player console 24.

In the present preferred embodiment, instructions for entering values of the auto-play parameters are displayed on the instruction and information display 152. In the present preferred embodiment, upon the instructions displayed on the console display 152, some switches 150 of the remote player console 24 are identified, and used for entering values of auto-play parameters. Once the values of auto-play parameters have been entered, the remote player console 24 is participating automatically in a number of remote games until the parameter values have been reached or when the same bar code ticket 77 that has been used to set the auto-play mode is read again by the bar code reading means 209 associated to the corresponding remote player console 24.

An other manner for simplifying the betting operation, for player located remotely from the underlying game, is providing simplified conditions for one or more remote 14 players requiring a selection of betting options being applicable for a whole of the play of the underlying game without requiring real-time input from the player, and permitting a remote player 14 to be concentrated on viewing and enjoying the underlying game atmosphere and/or alternatively, pursuing another activity without needing to provide real-time input to place a bet in the underlying game.

In the present embodiment, the player 14 can choose betting option between two sets of betting options offered for a same underlying casino game.

Different sets of betting options can be offered depending on the underlying casino game.

For a roulette underlying game 54 or craps underlying game, one, some or all betting options usually offered by roulette or craps game can be offered. An important aspect of the present invention is that the betting option selection period window is enlarged compared to the betting period window offered to player playing the underlying casino game at the underlying game location.

In the present preferred embodiment, the underlying game is a roulette game 54. Two sets of betting options are offered to remote players 14 for a same underlying game 54.

The first set of betting options is a subgroup of betting options offered by the casino underlying casino roulette game 54. Namely, the betting options offered by the first set are “Straight up” bet 172 on a number among 1 to 36, 0, 00; Bet on the parity: “Odd” 168 or “Even” 162; Bet on colors: “Red” 164 or “Black” 166; and bet on a numerical range: “1 to 18” 160 or “19 to 36” 170.

The second set of betting options offered is a bet on an unique combination of gaming symbols associated to the underlying game 54. In the present embodiment, the betting options are restricted only on combination of one or many numbers among 1 to 36, 0, and 00.

For card games such Poker, Baccarat or Blackjack, simplified conditions are provided for one or more remote players 14 requiring selection of a betting option to play the underlying game. The betting option being applicable for a whole of the play of the underlying game without requiring real-time input from the remote players 14 located remotely from an underlying game in a gaming environment.

In one preferred embodiment, the betting option is a bet on an unique combination associated to the underlying game wherein the unique combination comprises at least one gaming symbol among the following: suits: Spades, Clubs, Diamonds, Hearts; face values: 1, 2, 3, 4, 5, 6, 7, 8, 9, 10, Jack, Queen, King, Joker; and colors: red, black, white. The unique combination is to be matched with one or many card hands possessed by one or many players 12 or by a dealer 10 of the underlying game.

In the present preferred embodiment, activated lights besides each betting options switches comprised in the corresponding set of betting options indicate betting options for each set of betting options.

In the present embodiment, remote players 14 make bets with their remote player console 24. The remote player 14 selects switches or buttons corresponding to the betting option selected 226. In the present preferred embodiment, a player selects an amount of credits wagered on a betting option in activating the corresponding switches or buttons that permits to increment or decrement the number of credit wagered on the betting option. The amount of credit wagered for a betting option is displayed by the alphanumerical display 174 associated to the betting option switch or button 150. A player 14 determines the value of each credit by the activation credit value multiplied by switch or button 184.

The remote player console player account amount is decreased and the credit value indicated by the credit bank display 204 is decreased by the total credit amount of bets wagered 228. Players validate their remote bets 230 in activating the validate bet switch 176. The betting option selected and validated are stored in the player betting option memory 132. In the present embodiment, the betting option memory 132 is in integrated into the remote player console 24.

At the underlying live casino table game 54, the dealer 10 activates the “place remote bet” switch on the underlying game interface 32. In the present embodiment, the dealer 10 activates the “place remote bet” switch 236 of the underlying game interface 32, which is, in the present embodiment, a dealer keypad 32. Depending on the type of the underlying casino game, the dealer 10 activates the “place remote bet” switch of the underlying game interface 32, at the beginning, during processing or at the end of the underlying casino game. Furthermore, the moment to activate the “place remote bet” switch or button is determined according along the type of outcome produced by the underlying casino game, and by the type of remote betting options offered to remote players 14. For example, for card games, the dealer activates preferably the “place remote bet” switch before of dealing the cards to players 12 in a manner as the players 14 at remote player consoles 24 cannot validate their remote bets after the dealer 10 deals cards to players 12 of the underlying card game.

When the “place remote bet” switch or button is activated, a signal is sent from the underlying game interface 32, in the present embodiment a keypad, to the game controller 20. Upon reception of the signal, the game controller 20 sends a signal to each remote player console 24 to deactivate the “Place Bets” indication 178 and activate “Standby” indication 180. The “Standby” indication 180 activated 238 is the signal to communicate to each remote player 14 that the period to bet on the present progressing remote game approaches its end. Furthermore, upon the reception of the signal, the game controller 20 sends signals to the random gaming symbol selector 44, to the random remote player selector 46, and to the random remote player group selector 48 for initiating the random selection processes 242, 246, 244.

A predetermined period of time after the “Standby” indication 180 has been activated, the “Standby” indication 180 is automatically deactivated, and the “Bet Off” indication 182 is activated 240. In the preferred embodiment, the “Bet Off” indication 182 is a red LED, and when activated, indicates to players 14 that no more bets are accepted on the present remote game in progress. At this moment, the remote player console 24 is in OFF remote bet recording state for the present remote game in progress 232.

In referring to FIG. 7, the method of the present invention comprises the step of providing a remote view 212.

In the present preferred embodiment, a plurality of underlying game monitors 26 in communication with one or a plurality of camera 28 focusing on one or a plurality of underlying games 54, are positioned in a manner to permit remote player 14 to view in real-time the processing of the underlying game. Some underlying game monitors 26 could be associated to remote player consoles 24. Other underlying game monitors 26 are located in a manner to permit a view of the underlying game from a plurality of remote player console 24 locations.

It will be appreciated that the remote player consoles 24 need not have video displays for the video feed of the underlying game, and instead rely on a main common monitor 26, such as a wall or ceiling mounted monitor or screen, for a number of remote player consoles 24. This allows smaller consoles 24 to be used, and for the focus of remote players to be at a distance. This is less distracting for the remote players, who may be having a conversation in a lounge as illustrated in FIG. 3B. Multiple common displays 26 may also be provided for following a plurality of underlying games remotely by the players in an area.

Furthermore, in the present preferred embodiment, one or a plurality of remote player consoles 24 are located in such a manner to permit a player located at a remote player console 24 to directly view an underlying game 54 activity.

Viewing the intrinsic activity in real time of the underlying casino game directly or by an underlying game monitor 26, remote players 14 can appreciate the atmosphere of an underlying game, and can decide to bet with the remote player console 24 on a game played in conjunction with an underlying game played remotely.

In referring to FIG. 7, the method comprises further the step of processing the bet request 214.

When, the remote player console 24 is in OFF remote recording state for a processing underlying game, the remote player betting options stored into the console betting option memory 132 for the processing underlying game are sent and stored into a remote player betting option memory 134 in communication with the game controller 20. In the preferred embodiment, the game controller betting memory 134 is integrated with the game controller 20. In the present preferred embodiment, a first percentage of the total credit amounts of remote bets is stored 254 in a Jackpot Fund memory 146. A second percentage of the total credit amounts of remote bets is stored 252 in a Reserve Fund memory 144. A third percentage of the total credit remote bet amount goes 250 to Casino House Incomes Fund and Operator Fund memory 142. In the present preferred embodiment, the incremented Jackpot Fund corresponding to the Progressive Jackpot. The Progressive Jackpot can be displayed 256 on the wall display 72, on a game message display 114, on underlying game monitor 26, and on the remote player console display 152 according to different embodiments of the present invention.

Furthermore, a predetermined period of time after the random selection processes (i.e. predetermined virtual event(s)) have been initiated, selections take place. The randomly selected values (i.e. results), in the present embodiment, identifying such: a combination of gaming symbols associated to the underlying game, a group of remote players, and a remote player are registered and stored 258 into a result memory 136 in communication with the game controller 20. According to the present preferred embodiment, the result(s) of the predetermined virtual events are displayed 262 on a random selection result display 112 on the underlying game monitor 26, on the wall display 72 and on player console result displays 154, 198, and 200.

During the underlying game is played, the dealer 10 enters on the underlying game interface 32 outcomes of the play of the underlying game 54. Depending of the type of the game, the dealer will register outcomes at different moment during the proceeding of the underlying game 260.

In the present preferred embodiment, randomly selected results are a winning number of the roulette game, a color identifying a group of remote player consoles 24, and a number identifying uniquely a remote player console 24.

In the present preferred embodiment, for an underlying roulette game 54, the dealer 10 registers the number randomly selected by the ball, as soon as the ball is stopped into a numbered slot of the roulette wheel. In the present preferred embodiment, once the outcome of the roulette game is entered into the underlying game interface 32, the outcome entered by the dealer 10 into the underlying game interface 32 is displayed on the outcome confirmation device display 102. If the displayed outcome corresponds to the real outcome of the play of the underlying game 54, the outcome confirmation switch 100 is activated by the dealer 10, a player 12 or another individual. The activated outcome confirmation device switch 100 initiates the underlying game outcome data transmission from the underlying game interface 32 to the game controller 20. The game controller 20 stores the outcome data corresponding to the underlying game 54 into an outcome memory 138 in communication with the game controller 20. In the present embodiment, the game controller outcome memory 138 is integrated into the personal computer 60. The registered outcomes of the play of the underlying casino game are displayed 264 on the outcome display 110, on the wall display 72, on the underlying game monitor 26 and on the remote player console outcome display 208.

It will be understood that many electronic or electrical-mechanical apparatuses and systems have been developed during recent years for a plurality of casino games such as the roulette game.

For some roulette games, a dealer 10 has to spin the wheel, for other roulette games, a dealer 10 has to activate a switch to signal the electrical-mechanical wheel to spin. Furthermore, some roulette games do not require a dealer 10 to spin the wheel. For some roulette games, the dealer 10 has to launch the ball, and for other roulette games, the ball is launched automatically by the roulette game apparatuses and system. Finally, for roulette games, where the ball stands in the roulette wheel is read and determined by a dealer 10, for other roulette games the numbered slot where the ball stands is read and determined by game roulette apparatuses and system. Of course, in all cases, the method and system for controlling and managing bets in a gaming environment of the present invention can be applied. The difference, compared with the present embodiment, is that in some cases, roulette game apparatuses and systems instead of a dealer 10 activate the underlying game interface 32.

In a preferred embodiment, for a card game, the dealer 10 registers one or many cards comprised into one or many card hands possessed by one or many players 12 or by the dealer. 10. In a preferred embodiment, the card hand registered is a high value card hand of play of the underlying game. In other preferred embodiment, the dealer 10 registers one or many winning players of play of an underlying card game. In such preferred embodiment, remote players 14 could wager on one or many underlying game players 12. In a preferred embodiment, for card games, the card gaming symbols are preferably registered by the dealer 10 at the end of play of an underlying game for not disturbing the processing of the underlying game.

Furthermore, in another preferred embodiment, each card dealt is registered automatically by an electronic card reader as a card leaves the card shoe. Using a card reader permits to diminish the possibility of cheating, and to not interfere with the underlying card game process.

In a preferred embodiment, for a dice game, the dealer registers one or many numbers appearing on one or many dices rolled by a player 12 or a dealer 10. Furthermore, in a preferred embodiment, a dealer 10 registers individual who rolls dices. Such preferred embodiment, remote players could wager on one or many underlying game player 12.

Referring to FIG. 7, the method comprises further the step of determining a payout 216.

In a preferred embodiment, once the remote player bets have been stored in a game controller remote player betting option memory 134—in the present preferred embodiment; the game controller betting option memory 134 is integrated into the personal computer 60. Once, the randomly selected result(s),—in the present embodiment: number identifying a remote player console 24, a color identifying a group of remote player consoles, and a gaming symbol related to the underlying game; in the present embodiment, the gaming symbol is a number among 1 to 36, 0, 00—have been stored into a result memory 136. In the present preferred embodiment the result memory 136 is integrated into the personal computer 60. Once, outcome(s) of play of a corresponding underlying game have been stored into the outcome memory 138 in communication with the game controller 20. In the present embodiment, the outcome memory 138 is integrated into the personal computer 60. The remote player betting options, stored into the game controller betting option memory 134, associated with a particular play of the underlying game, are compared with outcomes, stored into the game controller outcome memory 136, of the corresponding play of the underlying game. Furthermore, in the present preferred embodiment, the remote player betting options, stored into the game controller betting memory 134, of the corresponding play of the underlying game are, also compared with result(s), stored into the game controller result memory 136, for the corresponding play of the underlying game 268.

Depending of the presence, or not, of a match between a bet option made by a remote player with one or some virtual event results and/or with one or some underlying game outcomes, a prize is awarded 270. Depending upon the degree of match a plurality of prizes of different credit amounts can be awarded. The prize could be a predetermined prize or a randomly selected prize selected by the random prize selector 50 in communication with the game controller 20.

The prize value could be a predetermined fixed amount, a randomly selected determined amount among a plurality of determined amount, a predetermined percentage of a jackpot, or a randomly selected percentage of a jackpot.

Depending of the case, the random prize selector 50 selects randomly a percentage among a plurality of percentages or a predetermined amount among a plurality of determined amounts.

For example, in the present preferred embodiment, a remote player 14 has access, in using a remote player console 24, to two sets of betting options for an underlying roulette game 54.

The first set of betting options is a subgroup of betting options offered by the underlying casino roulette game 54. Namely, the betting options offered by the first set are: “Straight up” bet 172 on a number among 1 to 36, 0, 00; bet on the parity: “Odd” 168 or “Even” 162; bet on colors: “Red” 164 or “Black” 166; bet on a numerical range: “1 to 18” 160 or “19 to 36” 170.

The second set of betting options is restricted only on a combination of one or many numbers among 1 to 36, 0, and 00.

Furthermore, in the present embodiment, a remote player console 24 is identified as a member of a group of remote player consoles 24 by a color and a remote player console 24 is identified uniquely by a number.

In the present embodiment, for each play of an underlying roulette game 54, a number identifying uniquely a remote player console 24, a color identifying a group of remote player consoles and a gaming symbol associated to the underlying game are randomly selected respectively by a random remote player selector 46, a random remote player group selector 48 and a random gaming symbol selector 44.

Depending on the degree of match between, on one side, the bet made with a particular remote console 24 on a play of the underlying game 54, and on the other side, the outcome and the randomly selected results of the corresponding play of the underlying game, a plurality of prizes could be awarded.

For example, according to the present preferred embodiment, a remote player 14 has made a bet on the number 14 on a play of the underlying roulette game 54. Furthermore, the remote player console 24 is identified by a remote player group color; the color “red”, and is uniquely identified by the number “99”. If the outcome of the corresponding play of the underlying game is “14”, there is a match between the player bet and the outcome. Then the remote player 14 is eligible to win a prize. Furthermore, if the random selection of a group of remote player color of the corresponding play of the underlying game is “red”, there is a second match. Then, the remote player is eligible to win a higher prize value. And so on, until the maximum of matches will be reached.

In the present embodiment, the maximum of matches will be reached when: the bet made by the remote player 14 matches the outcome of the play of the underlying game; the group remote player console color, and the remote player console number of the remote player console 24 of the remote player 14 matches the randomly selected color and number; and finally, the randomly selected gaming symbol matches the outcome of the corresponding play of the underlying game.

For this situation, where the remote player 14 has bet on the winning number of the roulette game, and for which the color, and the number identifying his remote player console 24 has been randomly selected by the random remote player selector 46 and by the random remote player group selector 48, and the random selected gaming symbol matches the outcome of the game, for this situation, the corresponding remote player 14 is eligible for the highest value prize. The highest value prize could be a fixed or a random percentage of the jackpot amount, a random or a determined prize amount. Depending the way that the casino decides to determine the prizes the random prize selector 50 could be used or not. The prizes could be, for example, a car, a voyage or a monetary amount etc.

As it could be appreciated, a plurality of combination of matches could be considered, and consequently a plurality of prize values could be awarded. Such prize values could be awarded randomly, random as randomly selected fixed amount, random as a percentage of a jackpot, fixed according to a pre-established charter, progressive as a predetermined percentage of wagers or a combination thereof as example, progressive and random as a random percentage of a jackpot.

Referring to FIG. 7, the present method comprises further the step of delivering the payout 218.

If there is a match with a remote bet made by a remote player 14 with a remote player console 24 a prize is awarded 272 according to a predetermined pay table or a random prize selection or a combination of the two. The prize amount is subtracted from the jackpot fund 274. The game controller 20 transfers the prize credit amount from the jackpot fund stored into the jackpot fund memory 146 to the player won credit account stored into a player won credit memory 140. In the present preferred embodiment, the won credit amount memory 140 is integrated into the remote player console 24. The remote player console credit/s won display 156 is incremented by the prize credit amount awarded 278.

After all prizes have been resolved, and the jackpot fund has been subtracted 274 from all prizes awarded for a game, the Jackpot Fund is evaluated by the game controller 20. Of course, if none matches occur, none prizes is awarded, and consequently, none prize amounts are subtracted from the Jackpot Fund 276.

If the jackpot fund value is lower than the predetermined minimum jackpot threshold value than a amount of credits from the reserve fund is transferred to the jackpot fund is equal or higher than the minimum jackpot threshold value; Otherwise, if the jackpot fund value is equal or higher than the minimum jackpot value then no credits from reserve fund is transferred to the jackpot fund stored into a jackpot fund memory 146. In the present preferred embodiment, the jackpot fund memory 146 is integrated into the game controller 280.

An interesting feature is that even if the totality of jackpot fund is awarded as prizes, the new jackpot fund, and consequently the progressive jackpot value is never decreased until a zero value.

Furthermore, as it can be appreciated, even if no jackpot has been awarded, the jackpot fund value is evaluated against a minimum jackpot threshold value. For some reasons, a new increased or decreased minimum jackpot threshold value could have been established considering different parameters, such as the amount cumulated in the reserve fund.

The new calculated value of the jackpot fund corresponds to the new progressive jackpot value 286.

When all prizes have been resolved, and jackpot fund has been reevaluated, the jackpot fund is stored in a jackpot fund memory 146. The prizes awarded 282, the winning match combinations 284, and new progressive jackpot 288 are communicated by game controller 20 to wall display 72, on the console game message display 152 and on the game message display 114. Furthermore, in the present preferred embodiment, underlying game outcomes, randomly selected results and prizes awarded are surmised on the real-time image of the underlying game monitor 26. The remote player 14 can pursue to bet on next remote games and enjoying the atmosphere and the intrinsic activity of the underlying game and/or to pursue another activity such as playing at another casino game, playing at a gaming machine or drinking at a bar.

When the remote player 14 wants to convert his credit into a monetary value device or tangible prizes, the remote player 14 must transfer the player credit amount stored into a won credit memory 140 into his player credit account memory 130. The player won credit memory 140 is in communication with the remote player console 24. In the present preferred embodiment, the remote player 14 activates the credit transfer switch 158. The credit transfer switch 158 activated generates the transfer of the won credit amount stored into the console player won credit memory 140 into the console player credit account memory 130. The bank credit display 204 displays a credit amount incremented of the won credit amount transferred into and added to the credit amount stored into the player credit account memory 130. The credit account memory is in communication with the remote player console 24. The credit account memory 130 could be a portable storage device 128 such a smart card or magnetic card. In the present preferred embodiment, the player credit account memory is integrated into the remote player console 24. According to different preferred embodiments the credit account amount can be transferred from the console credit account memory 130 into a credit transaction station 22 associated with the remote player console 24, into a credit account portable storage device 128, or into a player account memory 126 in communication with the game controller 20.

In the case where the credit amount is transferred into a credit transaction station 22, the player activates the console credit cash out switch 202. The activated console credit cash switch 202 initiates the transfer of the player credit account amount into the credit transaction station 22. Upon reception of the player credit account amount data, the credit transaction station 22 converts in a monetary value the player credit account amount. The credit transaction station 22 stores into or delivers a monetary value device 120 the corresponding monetary credit value of the player credit account amount. The monetary value device can be a smart card, a credit card, magnetic card, coins, bills or tickets.

In the case where the player credit account amount is transferred into a credit account portable storage device, the player 14 activates the console cash out switch 202. The credit account data comprising the player credit account amount and the player credit account code are stored into the credit account portable storage device 128. The portable storage device could be a smart card or a magnetic card. As shown in FIG. 3C, the remote player 14 goes to the casino bank 119. At the casino bank 119 the casino employee 16 inserts the portable storage device into an appropriate reader in communication with game controller 20. The reader reads the credit account code and the credit amount stored into portable storage device 128. The game controller 20 converts the credit amount into a monetary value and displays the credit account amount and the corresponding monetary amount value on the output command monitor 68. The game controller 20 compared the read account code with player account codes stored into the game controller player credit account memory 126. If the read code corresponds to a stored player account code, the game controller 20 validates. Upon the reception of the validated account code data the game controller 20 displays on the command output monitor 68 the validated account player code prompt. Otherwise, the game controller 20 displays a wrong player account code prompt. The casino employee 16 pays the monetary amount displayed on the monitor 68 to the player 14 in the case where the credit account code is validated. Once the corresponding monetary value is paid to the player 14, the casino bank employee 16 erases the player credit account code of the game controller player credit account memory 126.

As in the present preferred embodiment, in the case where the player credit account amount is transferred into a player account memory 126 in communication with the game controller 20. The player 14 activates the cash out switch 202 and presents his credit account portable storage device 128 to the remote player console 24 in order to communicate the player account code associated to the transferred credit amount into the game controller credit account memory 126. The presented portable storage device 128 is presented or inserted into an appropriate reader means associated with the remote player console 24. The credit account data portable storage device could be a smart card, a magnetic card or a bar cod ticket. In the present embodiment, the remote player 14 presents is bar code ticket 77 to the bar code scanner 209 integrated into the remote player console 24. When the player credit account amount is transferred from the console player account memory 130 to the game controller 20 player account memory the bank display 204 displays a zero credit amount. The remote player 14 goes to the casino bank. The bar code ticket is scanned by the casino bank employee 16 with a bar code reader 62 connected to the game controller 20. In the present preferred embodiment, the controller is integrated into a personal computer 60. The bar code reader 62 reads the bar code and transmits the read player credit account code to the game controller 20. Upon reception of the player credit account code, the game controller 20 compares the player account code to account codes stored into the game controller player account memory 126. If the received player account code matches a credit account code among credit account codes stored into the game controller player account memory 126, the game controller sends the validated credit account code data and the corresponding credit account amount data to the monitor 68 connected to the game controller 20. When the validated credit account code prompt and the credit account amount monetary value are displayed on the monitor 68, the bank employee 16 gives to the remote player 14 the monetary value device corresponding to the credit account amount displayed. Once the player 14 has been paid the player account code is erased from the game controller player account memory 126.

In the present preferred embodiment, a report printer 70 is connected to the game controller 20, which is integrated into a personal computer 60. The report printer 70 prints reports of data, and results concerning remote games played. In the present embodiment a command input keyboard 64 and command output monitor 68 are also connected to the game controller 20 in order to set remote game operation parameters, and to enter remote game operation data.

Although the present invention has been explained herein above by way of preferred embodiments, thereof, it should be noted that any modifications to these preferred embodiments within scope of the appended claims is not deemed to alter or change the nature and scope of the present invention.

1. A system for allowing a remote player to play a live casino table game, the system comprising:
a live casino table game interface for collecting live play data about a play of the table game;
a player console located away from the live casino table game for collecting bet data from a remote player;
a game controller connected to the player console and to the game interface for collecting said bet data and said live play data to credit and debit an account of the remote player as a function of wins and losses according to rules of play; and
a video system providing a video display of the live casino table game to the remote player,
characterized in that
the game controller determines from said live play data when further bets may not be accepted for the current play of the table game and interacts with the remote player via the player console to confirm whether said bet data received from the remote player should be applied to a subsequent game, wherein the remote player plays the live casino table game remotely at a same rate and rhythm as players at the live casino table game.

2. The system as claimed in claim 1, wherein the player console randomly selects said bet data from a set of predetermined betting options.

3. The system as claimed in claim 1, wherein said live play data includes game play data of at least one of the players and the dealer playing the live casino table game, and said bet data defines a simplified betting option including a game achievement status of a player or dealer involved in the live casino table game.

4. The system as claimed in claim 1, wherein the game achievement status is a win/lose status for each play of the live casino table game.

5. The system as claimed in claim 1, wherein the game controller calculates odds for said simplified betting option as a function of said live play data.

6. The system as claimed in claim 1, wherein said simplified betting option is maintained automatically for a plurality of plays of the live casino table game.

7. The system as claimed in claim 1, wherein said game controller also determines a random virtual event and credits the account of the remote player as a function of the random virtual event determines the remote player.

8. The system as claimed in claim 1, wherein the live casino table game is a roulette game, and the live casino table game interface interfaces with the roulette game.

9. The system as claimed in claim 1, wherein the live casino table game is a card game, and the live casino table game interface interfaces with the card game.

10. The system as claimed in claim 1, wherein said video system comprises a display screen installed for viewing by a plurality of remote players, the system comprising a player console for each of the plurality of remote players for collecting said bet data and controlling the remote player's account, while relying on said display screen to provide said video display of the live casino table game.

11. The system as claimed in claim 10, wherein said player console is portable, whereby said console may be provided in a lounge or restaurant.

12. The system as claimed in claim 1, wherein said player console is wireless.

13. The system as claimed in claim 1, wherein the player console provides the remote player with a choice of one of a plurality of said live casino table game for which said bet data is to apply.

14. A method of processing bet data in a system allowing a remote player to play a live casino table game, the system comprising:
a live casino table game interface for collecting live play data about a play of the table game;
a player console located away from the live casino table game for collecting bet data from a remote player;
a game controller connected to the player console and to the game interface for collecting said bet data and said live play data to credit and debit an account of the remote player as a function of wins and losses according to rules of play; and
a video system providing a video display of the live casino table game to the remote player,
the method comprising:
determining from said live play data when further bets may not be accepted for the current play of the table game;
interacting with the remote player to confirm whether said bet data received from the remote player should be applied to a subsequent game; and
applying said bet data to the subsequent game when confirmed;
wherein the remote player plays the live casino table game remotely at a same rate and rhythm as players at the live casino table game.

15. The method as claimed in claim 14, wherein the bet data identifies a simplified betting option including a game achievement status of a player or dealer involved in the live casino table game.

16. The method as claimed in claim 14, wherein the game achievement status is a win/lose status for each play of the live casino table game.

17. The method as claimed in claim 14, wherein odds for said simplified betting option are calculated as a function of said live play data.

18. The method as claimed in claim 14, wherein said simplified betting option is maintained automatically for a plurality of plays of the live casino table game.

19. The method as claimed in claim 14, further comprising a step of selecting one of a plurality of said live casino table games for which said bet data is to apply.
